(19) United States
(12) Patent Application Publication
(10) Pub. No.: US 2025/0179699 A1
(43) Pub. Date: Jun. 5, 2025

(54) Breathable Non-see-through Warp-knitted Fabric

(71) Applicant: Dongguan Best Pacific Textile Ltd., Dongguan (CN)

(72) Inventors: Mengmeng HAO, Dongguan (CN); Junyan HU, Dongguan (CN); Changrong CHEN, Dongguan (CN)

(73) Assignee: Dongguan Best Pacific Textile Ltd., Dongguan (CN)

(21) Appl. No.: 18/844,427

(22) PCT Filed: Mar. 28, 2022
(86) PCT No.: PCT/CN2022/083429

§ 371 Date: Sep. 6, 2024

(30) Foreign Application Priority Data
Mar. 7, 2022 (CN) 20221022065.5

(51) Int. Cl. D04B 21/12

(52) U.S. Cl. CPC D04B 21/12; D10B 2321/02; D10B 2331/10

(57) ABSTRACT

The present invention discloses a breathable and non-see-through warp knitted fabric, which comprises a fabric body, wherein the fabric body comprises an inelastic yarn and an elastic yarn, wherein the inelastic yarn and the elastic yarn are knitted in a warp knitting threading manner to form a knitting structure, wherein the inelastic yarn in the knitting structure is in a first warp plain weave structure of more than or equal to three needles, wherein the elastic yarn in the knitting structure is in a second warp plain weave structure, wherein the first and second warp plain weave structures are arranged in the same direction, and wherein the knitting structure has an empty through structure. The inelastic yarn and the elastic yarn of the warp knitted fabric of the present invention are knitted in a warp knitting threading manner to form a knitting structure, and the contraction of the elastic yarn, the warp plain weave structure and the empty through structure of the present invention achieve good breathability and anti-see-through effects.

### TECHNICAL FIELD

The invention relates to a textile fabric, in particular to a warp knitted fabric which is both breathable and non-transparent.

### BACKGROUND OF THE INVENTION

At present, the fabrics for sports/leggings available on the market have a gram weight of more than 180 gsm (grams per square meter), which feel stuffy and lack breathability when wearing them in hot summer. On the other hand, the fabrics with a gram weight of less than 180 gsm (grams per square meter) are too thin, which will easily reveal the clothes underneath during exercise, and can be embarrassing and not conducive to protecting the privacy of athletes. For example, Chinese patent application CN210501675U discloses “anti-permeability and moisture-absorbing knitted fabrics, which include a body, wherein the inner surface of the body is connected to a skin-friendly cotton fabric layer by an adhesive, the outer surface of the skin-friendly cotton fabric layer is connected to a pure cotton fiber fabric layer by an adhesive, and the surface of the pure cotton fiber fabric layer is connected to a nylon moisture-absorbing and perspiration-wicking fabric layer by an adhesive. The new type of skin-friendly cotton fabric layer has a comfortable wearing effect. When sweat flows, the sweat enters the inner cavity of the pure cotton fiber fabric layer, the nylon moisture wicking fabric layer and the polyester moisture wicking fabric layer through the skin-friendly cotton fabric layer, and has a moisture absorption effect. The textile fabric layer has a sweat transmission effect. The inelastic moisture wicking fabric layer has a sweat wicking effect. The breathable pores have a quick drying effect, which solves the problem that the existing knitted fabrics do not have the moisture absorption function, resulting in the sweat cannot be discharged in time when wearing.” However, the fabric of the application is composed of a skin-friendly cotton fabric layer, a pure cotton fiber fabric layer, a nylon moisture wicking fabric layer, a polyester moisture wicking fabric layer, a textile fabric layer and a inelastic moisture wicking fabric layer, and is also connected by an adhesive, so the fabric is very thick and the scope of use is extremely limited.

In addition, Chinese patent application CN113832592A discloses “a honeycomb structure breathable and cool knitted fabric and clothing including weaving lines for fabric weaving and molding, the weaving lines are intertwined to form a panel, the weaving lines are set as lines that can be used for heat dissipation, the adjacent weaving lines in the panel are mutually intertwined to form a honeycomb groove, and the panel is provided with an anti-stretching structure for preventing the toughness of the honeycomb groove from deformation. The application designs the line body of the weaving line to have a heat dissipation structure, and each weaving line is bent and knitted to form a continuous honeycomb groove. The weaving line is self-entangled when it is continuously bent and knitted, so that it has the effect of resisting tensile deformation. The adjacent weaving lines are intertwined through a honeycomb mold and intertwined between the line bodies to form interwoven joints. The intertwined joints between adjacent weaving lines form a diamond-shaped anti-stretching groove, so that the fabric has a high-strength anti-stretching effect, and the stability of the honeycomb structure is proved, so that the clothing made of the fabric is breathable and cool to use”. The disclosed invention uses a number of equally spaced honeycomb grooves to form a honeycomb structure for ventilation and heat dissipation; although it is relatively good in terms of air permeability, due to the honeycomb structure, this fabric is prone to being see-through during exercise and has poor anti-see-through performance.

Therefore, there is an urgent need for a warp knitted fabric that is both breathable and not see-through.

### SUMMARY OF THE INVENTION

The object of the present invention is to provide a breathable and non-see-through warp knitted fabric, which has both good breathability and good anti-see-through effect, ensuring that it is not see-through while being breathable.

To achieve the above-mentioned object, the present invention provides a breathable and non-transparent warp knitted fabric, which includes a fabric body, wherein the fabric body includes inelastic yarn and elastic yarn, the inelastic yarn and the elastic yarn are knitted in a warp knitting threading manner to form a knitting structure, the inelastic yarn in the knitting structure is a first warp structure of greater than or equal to three needles, the elastic yarn in the knitting structure is a second warp plain structure, the first warp plain structure and the second warp plain structure are arranged in the same orientation. The knitting structure has an non (empty) threading structure, and the inelastic yarn and the elastic yarn are knitted in a warp knitting threading manner of 0≤i≤10 needles, wherein i is the number of empty needles (stitches).

Preferably, the warp knitting threading method of the fabric body of the breathable and non-transparent warp knitted fabric of the present invention satisfies the following formula:

$$a = \frac{n - 1}{m + i} ;$$

wherein i is the number of empty needles, m is the number of threading needles, n is the number of warp flat cross stitches, a is a positive integer, 1≤i≤10.

Preferably, the number of warp flat cross stitches of the breathable and non-transparent warp knitted fabric of the present invention is 3≤n≤7.

Preferably, the inelastic yarn and the elastic yarn in the knitting structure of the breathable and non-transparent warp knitted fabric of the present invention are also arranged in a warp flat structure with the same needle gauge (distance), the inelastic yarn and the elastic yarn are threaded in the same way, and the guide bar used for the inelastic yarn and the guide bar used for the elastic yarn are arranged in a relative needle-matching manner.

Preferably, the inelastic yarn of the breathable and non-transparent warp knitted fabric of the present invention includes thick yarn and thin yarn, the thick yarn and the thin yarn have different diameters, the diameter of the thick yarn is larger than the diameter of the thin yarn, and the thick yarn and the thin yarn are in an in/out (threaded/non-threaded) matching structure in the knitting structure.

Preferably, the inelastic yarn and the elastic yarn of the breathable and non-transparent warp knitted fabric of the present invention are knitted in a warp knitting threading method with i=0 needles to form the knitting structure, and the inelastic yarn includes thick yarn and thin yarn, and the thick yarn and the thin yarn have different diameters, and the diameter of the thick yarn is larger than the diameter of the thin yarn.

Preferably, the number of the thin yarns between two adjacent thick yarns of the breathable and non-transparent warp knitted fabric of the present invention is A, wherein A≤3, the diameter of the thick yarn is B, the diameter of the thin yarn is C, and B: C≥1.1.

Preferably, the ratio of the yarn feeding amount of the thick yarn to the thin yarn of the breathable and non-transparent warp knitted fabric of the present invention is α, 0.7≤α≤1.5.

Preferably, the knitting structure of the breathable and non-transparent warp knitted fabric of the present invention satisfies the following formula: D=−1.44G+77.25; wherein D is the minimum yarn fineness required to achieve the function, and the unit of D is denier; G is the number of loom needles.

Preferably, the first warp plain structure and the second warp plain structure of the breathable and non-transparent warp knitted fabric of the present invention are one of a fully open warp plain structure, a fully closed warp plain structure, an open-and-closed warp plain structure, or any combination thereof.

Preferably, the fabric weight of the fabric body of the breathable and non-transparent warp knitted fabric of the present invention is E, wherein 50 gsm≤E≤250 gsm.

Preferably, the number of needles within one inch of the fabric body of the breathable and non-transparent warp knitted fabric of the present invention is F, wherein 28≤F≤50.

Compared with the prior art, the warp knitted fabric of the present invention has inelastic yarn and elastic yarn, and the inelastic yarn and elastic yarn are knitted to form a knitting structure by warp knitting threading, and the inelastic yarn in the knitting structure is a first warp plain structure of more than or equal to three needles, and the elastic yarn in the knitting structure is a second warp plain structure, and the first warp plain structure and the second warp plain structure are also arranged in the same direction; therefore, the contraction of the elastic yarn in the warp knitted fabric of the present invention makes the extension line part of the inelastic yarn bend and arch under the action of the elastic yarn force, and the yarns are close to each other, and at the same time, due to the warp plain structure, multiple needles are warped, and part of the structure has multiple extension lines between adjacent loop longitudinal rows (wale), thereby achieving an anti-see-through effect. At the same time, the warp knitted fabric of the present invention has an empty threading structure, so when the inelastic yarn and the elastic yarn are knitted by warp knitting threading, an empty threading method is adopted, and at the empty threading position, the distance between the yarns is larger than that of full threading in the horizontal direction, forming a smaller fabric lateral density, and the fabric is sparse in the horizontal direction, thereby achieving a good ventilation effect. At the same time, the inelastic yarn, elastic yarn, warp plain structure and empty threading structure of the present invention are combined and used to make the density at the continuous threading position larger and the density at the empty threading position smaller, with sparse and dense alternation. In addition to effectively balancing the air permeability and perspective performance, the weight per unit area of the fabric is also reduced. Therefore, compared with the full threading fabric, the warp knitted fabric structure of the present invention has the characteristics of lightweight.

### BRIEF DESCRIPTION OF THE DRAWINGS

FIG. 1 is a point diagram of the structure of embodiment 3 of the present invention.

FIG. 2 is a point diagram of the structure of embodiment 4 of the present invention.

FIG. 3 is a point diagram of the structure of embodiment 5 of the present invention.

FIG. 4 is a point diagram of the structure of embodiment 6 of the present invention.

FIG. 5 is a point diagram of the structure of embodiment 7 of the present invention.

FIG. 6 is a point diagram of the structure of embodiment 8 of the present invention.

FIG. 7 is a point diagram of the structure of embodiment 9 of the present invention.

FIG. 8 is a schematic diagram of the structure of embodiment 10 of the present invention.

FIG. 9 is a schematic structural diagram of comparative Example 5 of the present invention.

Explanation of references: Y1 is a thick yarn, and Y2 is a thin yarn.

### DETAILED DESCRIPTION OF THE INVENTION

The following is a clear and complete description of the technical solutions in the embodiments of the present invention in combination with specific implementation examples and drawings, and the technical solutions of the present invention are explained. Obviously, the described embodiments are only some, not all, possible embodiments of the present invention. Based on the embodiments of the present invention, all other embodiments obtained by ordinary technicians in this field without creative work are within the scope of protection of the present invention. Now, embodiments of the present invention are described with reference to the drawings, wherein similar component reference numbers represent similar components.

The breathable and non-transparent warp knitted fabric of the present invention comprises a fabric body, wherein the fabric body comprises an inelastic yarn and an elastic yarn, the inelastic yarn and the elastic yarn are knitted in a warp knitting threading mode to form a knitting structure, the inelastic yarn in the knitting structure is a first warp plain structure of more than or equal to three needles, the elastic yarn in the knitting structure is a second warp plain structure, the first warp plain structure and the second warp plain structure are arranged in the same direction, and the knitting structure has an empty threading structure. It can be seen that the warp knitted fabric of the present invention has an inelastic yarn and an elastic yarn, the inelastic yarn and the elastic yarn are knitted in a warp knitting threading mode to form a knitting structure, and the inelastic yarn in the knitting structure is a first warp plain structure of more than or equal to three needles, and the elastic yarn in the knitting structure is a second warp plain structure. The first warp plain structure and the second warp plain structure are arranged in the same direction, and the inelastic yarn and the elastic yarn are knitted in a warp knitting threading mode of 0≤i≤10 needles (stitches) to form the knitting structure, wherein i is the number of empty needles. Therefore, the contraction of the elastic yarn in the warp knitted fabric of the present invention makes the inelastic yarn extension line part bend and arch under the action of the elastic yarn force, and the yarns are close to each other. At the same time, due to the warp plain structure, multiple needles are warped flat, and the partial structure has multiple extension lines between adjacent loop longitudinal rows (wale), thereby achieving an anti-see-through effect. At the same time, the warp knitted fabric of the present invention has an empty threading structure, so when the inelastic yarn and the elastic yarn are knitted in the warp knitting threading mode, an empty threading mode is adopted. At the empty threading position, the distance between the yarns is larger than that of full threading in the horizontal direction, forming a smaller fabric transverse density, which is sparse in the horizontal direction, thereby achieving a good ventilation effect. At the same time, the combination of the inelastic yarn, the elastic yarn, the warp plain structure and the empty threading structure of the present invention makes the density at the continuous threading position larger, the density at the empty threading position smaller, and the density alternately sparse and dense. Thus, in addition to effectively balancing the ventilation and perspective performance, the weight per unit area of the fabric is also reduced, and therefore compared with the full threading fabric, the warp knitted fabric structure of the present invention has a lightweight feature.

As can be seen from the above, both the inelastic yarn and the elastic yarn can be knitted by the warp knitting threading method of 0≤i≤10 needles. Therefore, there are two different technical application examples here, one of which is the case where i is not equal to 0; the other is the case where i=0. These two cases are specifically described below.

Method 1, when i is not equal to 0:

In order to further improve the air permeability and anti-see-through effect of the present invention, preferably, the warp knitting threading method of the fabric body of the breathable and non-see-through warp knitted fabric of the present invention satisfies the following formula:

$$a = \frac{n - 1}{m + i} ;$$

wherein i is the number of empty needles, m is the number of threading needles, n is the number of warp flat cross needles, a is a positive integer, wherein 1≤i≤10 and 3≤n≤7.

More specifically, the air permeability and anti-see-through effect is more significant when the knitting structure formed by selecting the inelastic yarn and the elastic yarn and a warp knitting threading method of 1≤i≤10 needles, while ensuring that the fabric body has sufficient strength and practicality. Furthermore, the inelastic yarn and the elastic yarn in the knitting structure of the breathable and non-see-through warp knitted fabric of the present invention are also arranged with the same needle spacing, and the inelastic yarn and the elastic yarn are knitted in the same way and the guide bars are opposite to each other. Preferably, the inelastic yarn of the breathable and non-transparent warp knitted fabric of the present invention comprises a thick yarn and a thin yarn, wherein the diameters of the thick yarn and the thin yarn are different, the diameter of the thick yarn is larger than the diameter of the thin yarn, and the thick yarn and the thin yarn in the knitting structure are in a matching empty-threaded (out-in) structure pattern. The inelastic yarn of the present invention adopts the combination of thick yarn and thin yarn, and the appropriate yarn feeding ratio of thick yarn and thin yarn can be selected in a way known in the field, and the appropriate yarn feeding ratio will make the thin yarn capacity space small, and the excess space forms pores, which increases the air permeability effect. At the same time, the combination of thick yarn and thin yarn has a larger fabric surface evaporation area compared with the prior art combination of yarns of the same specification, so that the warp knitted fabric of the present invention has good air permeability and anti-perspective effect, and also has a good quick-drying effect. At the same time, with the empty-threaded matching of thick yarn and thin yarn, the addition of thin yarn in the empty-threading position can further improve the shielding effect.

Method 2, when i=0:

More specifically, the inelastic yarn and the elastic yarn of the breathable non-transparent warp knitted fabric of the present invention are knitted with a warp knitting threading mode of i=0 needles to form the knitting structure, the inelastic yarn includes a thick yarn and a thin yarn, the diameters of the thick yarn and the thin yarn are different, the number of the thin yarns between two adjacent thick yarns is A, wherein A≤3, the diameter of the thick yarn is B, the diameter of the thin yarn is C, and B: C≥1.1. The inelastic yarn of the present invention uses a combination of thick yarn and thin yarn, and the ratio of the yarn feeding amount of the thick yarn to the thin yarn is α, with 0.7≤α≤1.5. The ratio of the yarn feeding amount within this range will make the thin yarn space small, and the extra space forms pores, which increases the air permeability effect. At the same time, the combination of thick yarn and thin yarn has a larger fabric surface evaporation area compared with the prior art combination of yarns of the same specification, so that the warp knitted fabric of the present invention has good air permeability and anti-transparent effect, and also has a good quick-drying effect. At the same time, the thick yarn and the thin yarn are matched (complimentary) in non-threaded (empty) position and with thin yarn added into the empty position it further improves the shielding effect.

In order to further provide the air permeability, anti-see-through effect and quick-drying effect of the present invention; preferably, the n of the air-permeable and non-see-through warp knitted fabric of the present invention is ≤7. The knitting structure of the air-permeable and non-see-through warp knitted fabric of the present invention satisfies the following formula: D=−1.44G+77.25; wherein D is the minimum yarn fineness to achieve the function, and the unit of D is denier; G is the number of knitting machine needles.

Preferably, the first warp plain structure and the second warp plain structure of the breathable and anti-see-through warp knitted fabric of the present invention are one of a fully open warp plain structure, a fully closed warp plain structure, an open-closed warp plain structure, or any combination thereof.

Preferably, the fabric weight of the fabric body of the breathable and non-transparent warp knitted fabric of the present invention is E, wherein 50 gsm≤E≤250 gsm.

Preferably, the number of needles in one inch of the fabric body of the breathable and non-transparent warp knitted fabric of the present invention is F, wherein 28≤F≤50.

In order to further explain the present invention in detail and understand its implementation methods, the inelastic yarn and the elastic yarn are replaced by symbols known to those skilled in the art, that is, the inelastic yarn is represented by GB1 and the elastic yarn is represented by GB2; the positions of the inelastic yarn and the elastic yarn can be interchanged.

As used in the following, in FD FDY nylon. FD is the abbreviation of full dull, and FDY is the abbreviation of fully drawn yarn; in SD DTY nylon, SD is the abbreviation of semi-dull and DTY is the abbreviation of draw texturing yarn.

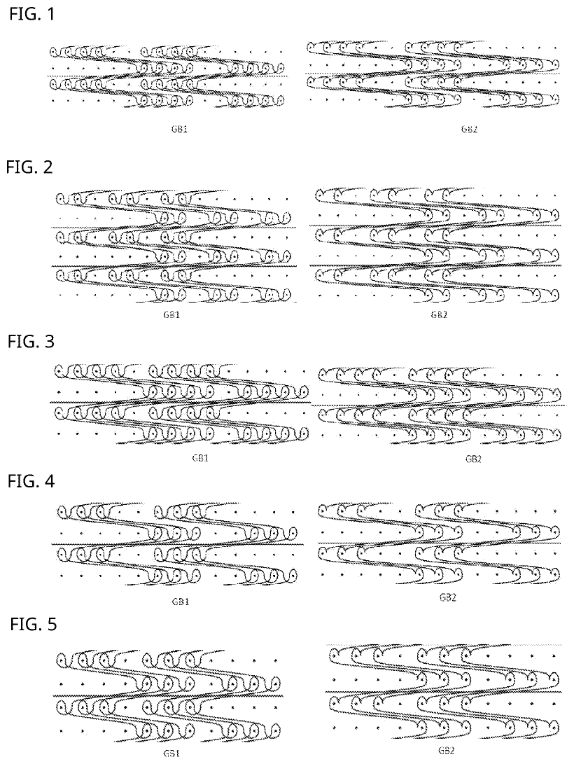

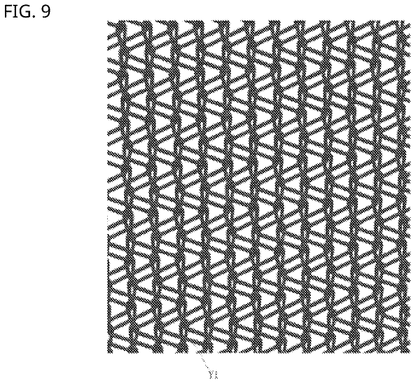

The breathable and non-transparent warp knitted fabric of the present invention is further described in detail with reference to FIGS. 1 to 9 and Table 1:

For the comparative examples, a plain knitting fabric of same appearance, with good perspective, was used to compare and evaluate the air permeability relative to the breathable and non-transparent warp knitted fabric of the present invention. A mesh cloth with excellent air permeability was used to compare and evaluate the perspective relative to the breathable and non-transparent warp knitted fabric of the present invention.

Embodiment 1: Using a 40-needle warp knitting machine (i.e., the number of needles F=40 needles), GB1, with 50D/48 F SD DTY nylon, uses the stitch pattern 1-0/2-3//, alternating 1-in and 1-out, and with the yarn feeding amount being 1200 mm/lacquer, GB2, with 30D spandex, uses the stitch pattern 0-1/3-2//, alternating 1-in and 1-out, with yarn feeding amount being 890 mm/lacquer, and the needles of GB1 and GB2 are opposite to each other.

Embodiment 2: Using a 32-needle warp knitting machine (i.e., the number of needles F=32 needles), GB1, with 100D/72F SD DTY polyester, uses the stitch pattern is 1-0/2-3//, alternating 1-in and 1-out, the yarn feeding amount being 1620 mm/lacquer, GB2, with 70D spandex, uses the stitch pattern 0-1/3-2//, alternating 1-in and 1-out, and the yarn feeding amount being 1010 mm/lacquer, and the needles of GB1 and GB2 are opposite to each other.

Comparative Example 1: Using a 40-needle warp knitting machine, GB1, with 20D/34F FD FDY nylon, uses the stitch pattern 0-1/2-1//, full threading, and the yarn feed amount being 910 mm/lacquer; GB2, with 30D spandex, uses the stitch pattern 0-1/2-1//, full threading, and the yarn feed amount being 500 mm/lacquer.

Comparative Example 2: Using a 32-needle warp knitting machine, GB1, with 50D/96F SD DTY nylon, uses the stitch pattern 0-1/2-1//, full threading, and the yarn feed amount being 970 mm/lacquer. GB2, with 30D spandex, uses the stitch pattern 0-1/2-1//, full threading, and the yarn feed amount being 550 mm/lacquer.

Comparative Example 3: Using a 32-needle warp knitting machine, GB1, with 40D/34F FD FDY nylon (inelastic yarn), uses the stitch pattern 1-0/1-2/2-3/2-1//, alternating 1-in and 1-out, and the yarn feeding amount being 1100 mm/lacquer. GB2, with 40D/34F FD FDY nylon (inelastic yarn), uses the stitch pattern 2-3/2-1/1-0/1-2//, alternating 1-in and 1-out, and the yarn feeding amount being 1100 mm/lacquer. GB3, with 30D spandex (elastic yarn), uses the stitch pattern 1-0/1-2/2-3/2-1//, alternative 1-in and 1-out, and the yarn feeding amount being 650 mm/lacquer. GB4, with 30D spandex, uses the stitch pattern 2-3/2-1/1-0/1-2//, alternating 1-in and 1-out, and the yarn feed amount being 650 mm/lacquer. GB4 has the elastic yarn.

Comparative Example 4: Using a 28-needle warp knitting machine, GB1, with 40D/48F FD FDY nylon (inelastic yarn), uses the stitch pattern 1-0/1-2/2-1/2-3/2-1/1-2//, alternating 1-in and 1-out, and the yarn feeding amount being 930 mm/lacquer. GB2, with 40D/48F FD FDY nylon (inelastic yarn), uses the stitch pattern 2-3/2-1/1-2/1-0/1-2/2-1//, 1-in and 1-out, and the yarn feeding amount being 930 mm/lacquer. GB3, with 420D spandex (elastic yarn), uses the stitch pattern is 0-0/1-1//*3, 1-out and 1-in, and the yarn feeding amount being 85 mm/lacquer. GB4, with 420D spandex (elastic yarn), uses the stitch pattern 1-1/0-0//*3, 1-out and 1-in, yarn feeding amount being 85 mm/lacquer.

Sampling: In the experiment, 0.5 yards of fabric were taken from the front, middle and back sections of a 50-yard cloth roll. Front each section, two pieces were taken, one for air permeability test and the other for perspective test.

Air permeability test: Using JIS L 1096 Method A, the air permeability of the three pieces of fabric of one sample was tested on the left, middle and right parts of each piece of fabric, and the average value was taken as the air permeability value result of each piece and the air permeability values of the three pieces of fabric were then averaged as the final air permeability value of the fabric.

Anti-see-through test: According to the Notice on Issuing the 2018 National Standard Formulation and Revision Plan (No. 68, Comprehensive of the Standardization Administration of China), the test and evaluation were carried out with reference to the “Testing and Evaluation of Anti-see-through Performance of Textiles” (Plan No.: 20183027-608) drafted by the National Technical Committee for Textile Standardization and the Basic Standard Branch of the National Textile Standardization Committee, with the lead drafter being the Shanghai Customs Industrial Products and Raw Materials Testing Technology Center.

The instrument method recommended by “Testing and Evaluation of Anti-See-Through Performance of Textiles” was adopted, using D65 10 Deg light source, and the white board and black board used for colorimeter calibration were required in the test. The coverage rate program was selected to directly measure the anti-see-through index S, which is the ratio of the brightness value of the black board backing the sample to the brightness value of the white board backing the sample. In the experiment, the three fabrics of the sample were tested, and the left, middle and right parts of each fabric were tested, and the average value was calculated as the anti-see-through index S value of each fabric; the average value of the three fabrics was calculated again as the final anti-see-through index S value of the fabric.

Evaluation index: Statistics on wearing experience of some polyester-spandex or nylon-spandex close-fitting fabrics: when the air permeability value is ≥70, the corresponding air permeability is good; when 70>air permeability value ≥50, the air permeability is average; when the air permeability value is <50, the air permeability is poor.

The anti-see-through value S is divided into three levels: poor, typical, and good, and the corresponding S value ranges are S≤93, 93<S<97, and S≥97. The larger the anti-see-through value, the better the anti-see-through effect. The comparison between air permeability and see-through is Table as follows:

TABLE 1

| | inelastic | | | | | Anti-see- |
|---|---|---|---|---|---|---|
| | yarn | | Air | | Anti-see- | through |
| | thickness | Weight | permeability | Breathability | through | performance |
| Fabric | (denier) | (g/m²) | (cm³/cm²/s) | evaluation | index S | evaluation |
| Example 1 | 50 | 125 | 108 | good | 97.21 | good |
| Example 2 | 100 | 195 | 97 | good | 97.82 | good |
| Comparative | 20 | 130 | 30 | Poor | 99.01 | good |
| Example 1 | | | | | | |
| Comparative | 50 | 135 | 45 | Poor | 98.63 | good |
| Example 2 | | | | | | |
| Comparative | 40 | 125 | 161 | good | 89.98 | Poor |
| Example 3 | | | | | | |
| Comparative | 40 | 195 | 178 | good | 90.74 | Poor |
| Example 4 | | | | | | |

In summary, the analysis shows that the breathable and non-transparent warp knitted fabric of the present invention has a significant improvement in the breathability in plain cloth, showing good air breathability, and has a significant improvement in the ant-see-through effect of mesh cloth, showing good anti-see-through performance, so it has both a good breathable and non-transparent effect. In order to further illustrate the breathable and non-transparent warp knitted fabric of the present invention, the following examples are further described.

Embodiment 3: As shown in FIG. 1, guide bar GB1 adopts 7-needle closed warp plain, stitch pattern 1-0/6-7//, 4-in and 2-out, guide bar GB2 adopts 7-needle open warp plain, stitch pattern 0-1/7-6//, 4-in and 2-out, GB1 and GB2 are opposite to each other, so that GB2 and GB1 yarns are always knitted on the same needles.

Embodiment 4: As shown in FIG. 2, guide bar GB1 adopts 7-needle closed warp plain, stitch pattern 1-0/6-7//, 2-in and 1-out, guide bar GB2 adopts 7-needle open warp plain, stitch pattern 0-1/7-6//, 2-in and 1-out, GB1 and GB2 are opposite to each other, so that GB2 and GB1 yarns are always knitted on the same needles.

Embodiment 5: As shown in FIG. 3, guide bar GB1 adopts 6-needle closed warp plain, stitch pattern 1-0/5-6//, 4-in and 1-out, guide bar GB2 adopts 6-needle open warp plain, stitch pattern 0-1/6-5//, 4-in and 1-out, GB1 and GB2 are opposite to each other, so that GB2 and GB1 yarns are always knitted on the same needles.

Embodiment 6: As shown in FIG. 4, guide bar GB1 adopts 6-needle closed warp plain, stitch pattern 1-0/5-6//, 3-in and 2-out, guide bar GB2 adopts 6-needle open warp plain, stitch pattern 0-1/6-5//, 3-in and 2-out, GB1 and GB2 are opposite to each other, so that GB2 and GB1 yarns are always knitted on the same needle.

Embodiment 7: As shown in FIG. 5, guide bar GB1 adopts 5-needle closed warp plain, stitch pattern 1-0/4-5//, 3-in and 1-out, and guide bar GB2 adopts 5-needle open warp plain, stitch pattern 0-1/5-4//, 3-in and 1-out. The needles of GB1 and GB2 are opposite to each other, so that GB2 and GB1 yarns are always knitted on the same needles.

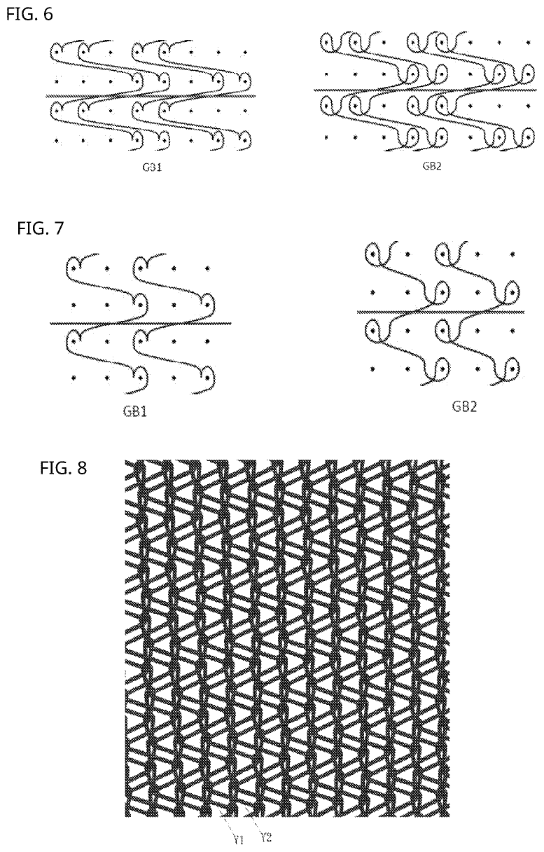

Embodiment 8: As shown in FIG. 6, guide bar GB1 adopts 4-needle closed warp plain, stitch pattern is 1-0/3-4//, 2 wears and 1 is empty, the guide bar GB2 adopts 4-needle open warp plain, stitch pattern 0-1/4-3//, 2-in and 1-out, GB1 and GB2 are opposite to each other, so that GB2 and GB1 yarns are always knitted on the same needles.

Embodiment 9: As shown in FIG. 7, guide bar GB1 adopts 3-needle closed warp plain, stitch pattern 1-0/2-3//, 1-in and 1-out, guide bar GB2 adopts 3-needle open warp plain, stitch pattern 0-1/3-2//, 1-in and 1-out, GB1 and GB2 are opposite to each other, so that GB2 and GB1 yarns are always knitted on the same needles.

Embodiment 10: As shown in the loop diagram of FIG. 8, three guide bars are used, guide bar GB1 is inelastic yarn, which is coarse yarn Y1, stitch pattern 1-0/2-3//, 1-in and 1-out, guide bar GB2 is inelastic yarn, which is fine yarn Y2, stitch pattern 1-0/2-3//, 1-out and 1-in, the GB1 and GB2 guide bars are opposite to each other, GB3 is spandex (elastic yarn), stitch pattern 1-0/1-2//, fully threaded. In this way, fabric A is formed, and the GB3 yarn of fabric A is hidden under GB1 and GB2.

Comparative Example 5: Two guide bars are used, GB1 uses roving Y1, stitch pattern 1-0/2-3//, fully threaded, GB2 uses spandex, stitch pattern 1-0/1-2//, fully threaded, resulting in fabric B.

When the density of fabric A and fabric B is the same, fabric A has larger pores and better air permeability than fabric B. Fabric A with the warp-pile flat structure, when compared with the double-warp flat appearance formed by the structure of Example 9, within a reasonable process range, the yarn coverage area is larger and the anti-see-through effect is better.

It is worth noting that the formula a=n−1/m+i can be better understood by taking the above-mentioned Example 9 as an example. Example 9 describes that “guide bar GB1 adopts 3-needle closed warp plain, stitch pattern 1-0/2-3//, 1-in and 1-out, guide bar GB2 adopts 3-needle open warp plain”, wherein the threading needle number m=1 (i.e. 1-in), the empty needle number i=1 (i.e. 1-out), the warp flat cross needle number n=3 (i.e. 3-needle closed warp plain), and finally a=1 is obtained. On this basis, the calculation can be conducted for other embodiments, and those skilled in the art can understand and implement other embodiments without needing any creative labor, and thus to avoid redundancy such description for other embodiments is herein omitted.

In addition, the materials, stitch patterns, guide bar settings and configurations, and warp knitting structures of the fabrics involved in the present invention are well known to ordinary technicians in the field and will not be described in detail herein.

It is obvious to those skilled in the art that the present invention is not limited to the details of the exemplary embodiments described above, and that the present invention can be implemented in other specific forms without departing from the spirit or essential features of the present invention. Therefore, in any events, the embodiments should be regarded as exemplary and non-restrictive, and the scope of the present invention is defined by the appended claims rather than the above description, and it is intended that all changes falling within the meaning and scope of the equivalent elements of the claims are included in the present invention. Any figure references in the claims should not be regarded as limiting the claims involved. Therefore, what is disclosed above is only the preferred embodiment of the present invention, and of course cannot be used to limit the scope of the present invention. Consequently, equivalent changes made within the scope of the present invention are still covered by the present invention.

1. A breathable and non-transparent warp knitted fabric, characterized in that it includes a fabric body, wherein the fabric body comprises an inelastic yarn and an elastic yarn, the inelastic yarn and the elastic yarn are knitted in a warp knitting threading manner to form a knitting structure, the inelastic yarn is a first warp plain structure of more than or equal to three needles within the knitting structure while the elastic yarn is a second warp plain structure within in the knitting structure, the first warp plain structure and the second warp plain structure are arranged in a same direction, and the knitting structure has an empty threading structure; the inelastic yarn and the elastic yarn are knitted in a warp knitting threading manner of 0≤i≤10 needles to form the knitting structure, i is the number of empty needles.

2. The breathable and non-transparent warp knitted fabric according to claim 1, characterized in that the inelastic yarn comprises short-staple yarn and long-staple yarn, and the elastic yarn comprises polyurethane yarn and polyolefin yarn; the positions of the inelastic yarn and the elastic yarn can be interchanged during knitting.

3. The breathable and non-transparent warp knitted fabric according to claim 1 or 2 is characterized in that the inelastic yarn and the elastic yarn are knitted into the knitting structure in a warp knitting threading method in which i is not equal to 0 needles, and the warp knitting threading method of the fabric body satisfies the following formula:
$$a = \frac{n - 1}{m + i} ;$$
wherein m is the number of threading needles, n is the number of warp flat cross needles, a is a positive integer, 1≤i≤10.

4. The breathable and non-transparent warp knitted fabric according to claim 3, characterized in that the number of warp flat cross needles is 3≤n≤7.

5. The breathable and non-transparent warp knitted fabric according to claim 4 is characterized in that the inelastic yarn and the elastic yarn in the knitting structure are also arranged in a warp flat structure with the same needle gauge, the inelastic yarn and the elastic yarn are threaded in a same way, and the comb bars used for the inelastic yarn and the comb bars used for the elastic yarn are arranged in a relative needle-matching manner.

6. The breathable and non-transparent warp knitted fabric according to claim 4 is characterized in that the inelastic yarn includes coarse yarn and fine yarn, the coarse yarn and the fine yarn have different diameters, the diameter of the coarse yarn is larger than the diameter of the fine yarn, and the coarse yarn and the fine yarn in the knitting structure are in an empty matching structure.

7. The breathable and non-transparent warp knitted fabric according to claim 1 or 2 is characterized in that the inelastic yarn and the elastic yarn are knitted in a warp knitting threading method with i=0 needles to form the knitting structure, and the inelastic yarn includes coarse yarn and fine yarn, the coarse yarn and the fine yarn have different diameters, and the diameter of the coarse yarn is greater than the diameter of the fine yarn.

8. The breathable and non-transparent warp knitted fabric according to claim 7, characterized in that the ratio of the yarn feed amount of the thick yarn to the thin yarn is a, 0.7≤a≤1.5.

9. The breathable and non-transparent warp knitted fabric according to claim 8, characterized in that the number of the thin yarns between two adjacent thick yarns is A, A≤3; the diameter of the thick yarn is B, the diameter of the thin yarn is C, B:C≥1.1.

10. The breathable and non-transparent warp knitted fabric according to claim 1 or 2, characterized in that the knitting structure satisfies the following formula: D=−1.44G+77.25; wherein D is the minimum yarn fineness required to achieve the function, and the unit of D is denier; and G is the number of loom needles.

11. The breathable and non-transparent warp knitted fabric according to claim 1 or 2, characterized in that the first warp knit structure and the second warp knit structure are one of a fully open warp knit structure, a fully closed warp knit structure, an open-closed warp knit structure, or any combination thereof.
